(19) United States
(12) Patent Application Publication
(10) Pub. No.: US 2024/0322620 A1
(43) Pub. Date: Sep. 26, 2024

(54) ELECTRIC MOTOR

(71) Applicant: Mitsubishi Electric Corporation, Tokyo (JP)

(72) Inventors: Kazuchika TSUCHIDA, Tokyo (JP); Ryogo TAKAHASHI, Tokyo (JP); Daisuke MORISHITA, Tokyo (JP); Takaya SHIMOKAWA, Tokyo (JP); Takanori WATANABE, Tokyo (JP)

(21) Appl. No.: 18/578,161

(22) PCT Filed: Aug. 30, 2021
(86) PCT No.: PCT/JP2021/031657

§ 371 Date: Jan. 10, 2024

(51) Int. Cl. H02K 1/18; H02K 3/32

(52) U.S. Cl. CPC H02K 1/18; H02K 3/325

(57) ABSTRACT

An electric motor includes a stator including a stator core, a first insulator provided on the stator core, a winding wound on the first insulator, a rotor including a rotor core, and a second insulator covering the stator. The stator core is shorter than the rotor core in an axial direction. The stator includes a magnetic material. The magnetic material is fixed by the first insulator and faces the rotor core. Density of the second insulator is greater than density of the first insulator.

### TECHNICAL FIELD

The present disclosure relates to an electric motor.

### BACKGROUND ART

Generally, electric motors in which a stator core is longer than a rotor core in the axial direction of the electric motor have been proposed (e.g., Patent Reference 1). The electric motor in which the stator core is longer than the rotor core has the advantage that magnetic flux from the rotor can easily flow into the stator core.

### PRIOR ART REFERENCE

### Patent Reference

Patent Reference 1: International Publication No. WO 2016/203592

### SUMMARY OF THE INVENTION

### Problem to be Solved by the Invention

However, if the stator core is longer than the rotor core in the axial direction of the electric motor, the volume of the electric motor increases and thus the cost of the stator core and windings disadvantageously increases. On the other hand, if the stator core is shorter than the rotor core in the axial direction of the electric motor, the magnetic flux that flows into the stator core from the rotor decreases, and thus the efficiency of the motor is disadvantageously reduced.

It is an object of the present disclosure to prevent a decrease in the efficiency of an electric motor by installing a magnetic material in a stator so that the magnetic material faces the rotor core, and to reduce a noise passing through an insulator that fixes the magnetic material.

### Means of Solving the Problem

An electric motor of the present disclosure includes:
a stator including a stator core including a yoke and a tooth, a first insulator provided on the stator core, a winding wound on the first insulator;
a rotor including a rotor core and disposed inside the stator; and
a second insulator covering the stator, wherein
the stator core is shorter than the rotor core in an axial direction,
the stator includes a magnetic material fixed by the first insulator, the magnetic material facing the rotor core, and
density of the second insulator is greater than density of the first insulator.

### Effects of the Invention

According to the present disclosure, a decrease in the efficiency of an electric motor can be prevented by installing a magnetic material in a stator so that the magnetic material faces the rotor core, and a noise passing through an insulator that fixes the magnetic material can be reduced.

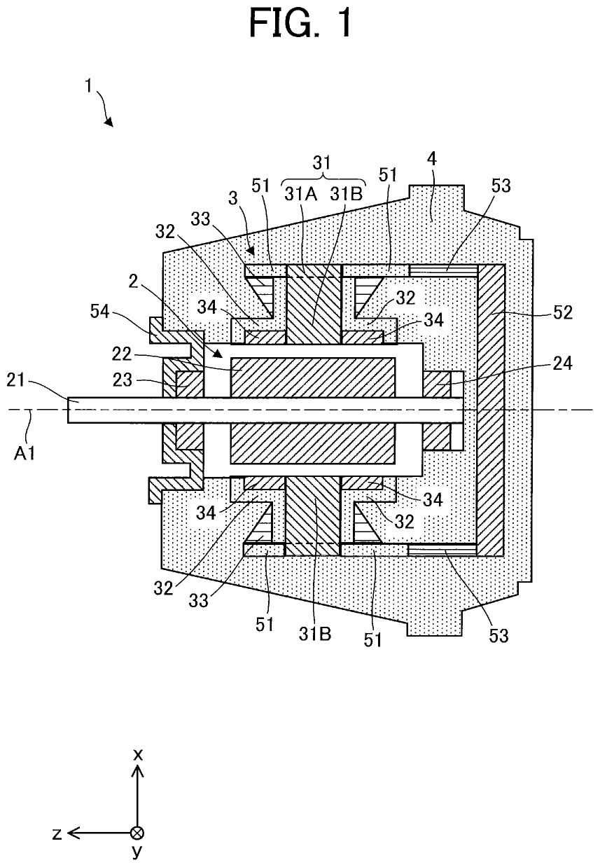

FIG. 1 is a cross-sectional view schematically showing an electric motor according to the embodiment.

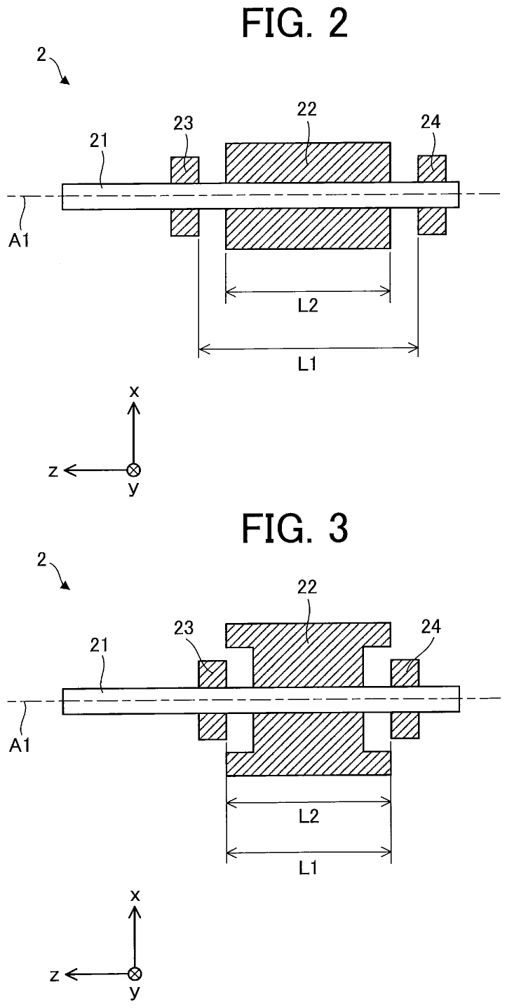

FIG. 2 is a cross-sectional view schematically showing a rotor.

FIG. 3 is a cross-sectional view showing another example of the rotor.

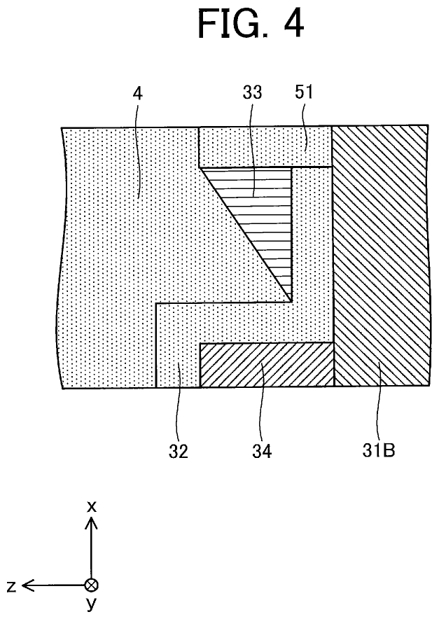

FIG. 4 is an enlarged view showing a structure around a magnetic material shown in FIG. 1.

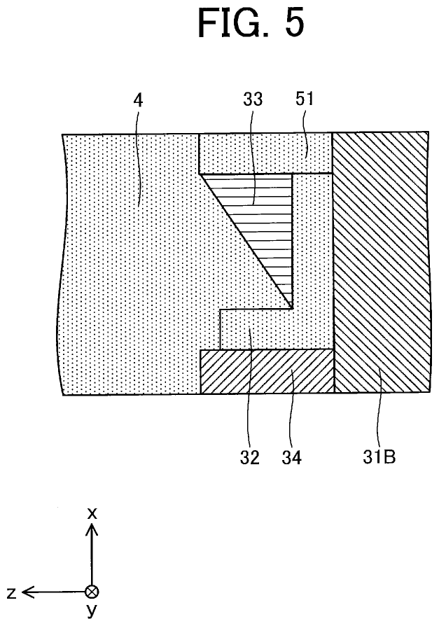

FIG. 5 is an enlarged view schematically showing another structure around the magnetic material.

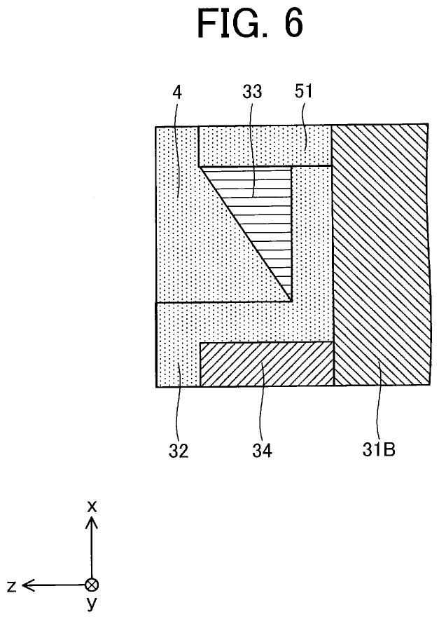

FIG. 6 is an enlarged view schematically showing still another structure around the magnetic material.

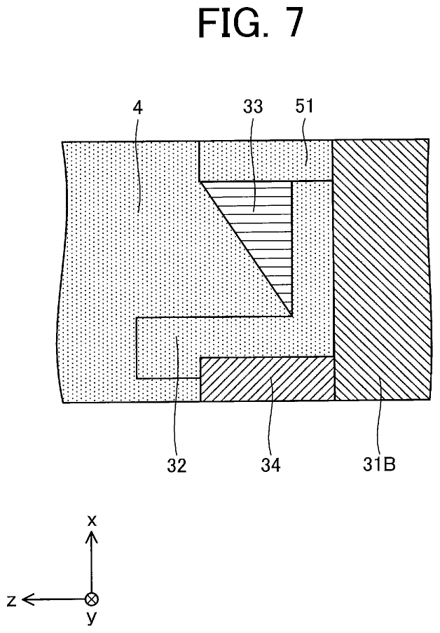

FIG. 7 is an enlarged view schematically showing still another structure around the magnetic material.

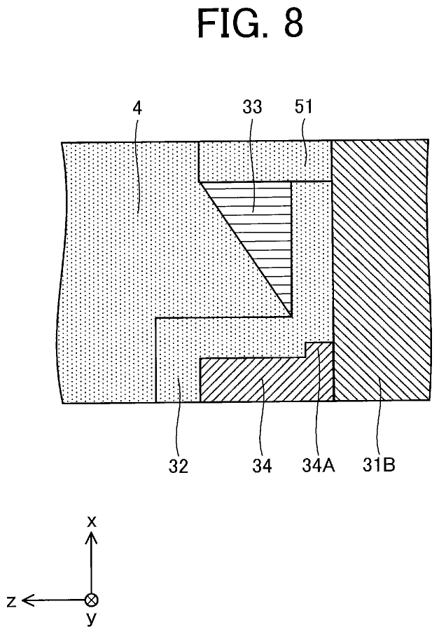

FIG. 8 is a cross-sectional view showing another example of the magnetic material.

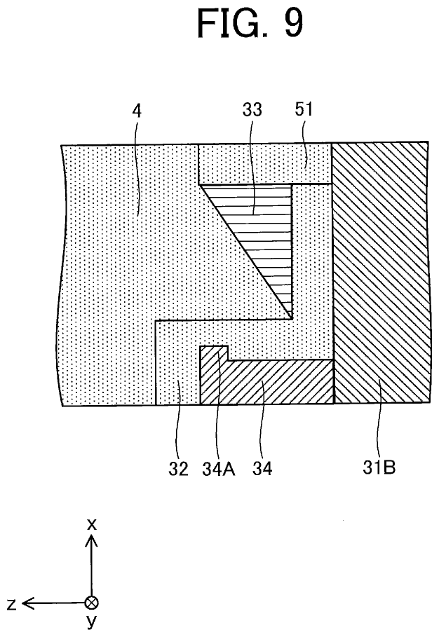

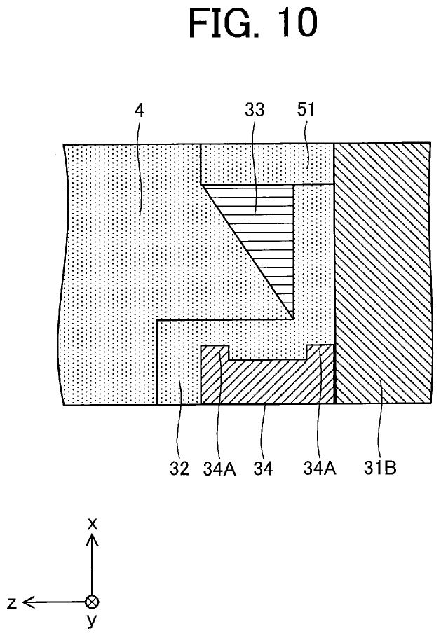

FIG. 9 is a cross-sectional view showing still another example of the magnetic material.

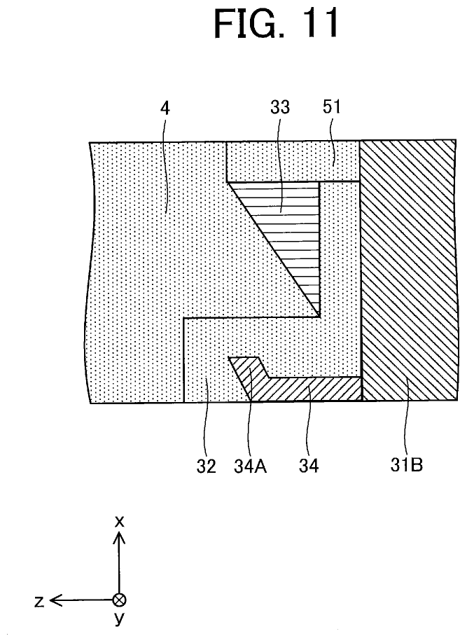

FIG. 10 is a cross-sectional view showing still another example of the magnetic material.

FIG. 11 is a cross-sectional view showing still another example of the magnetic material.

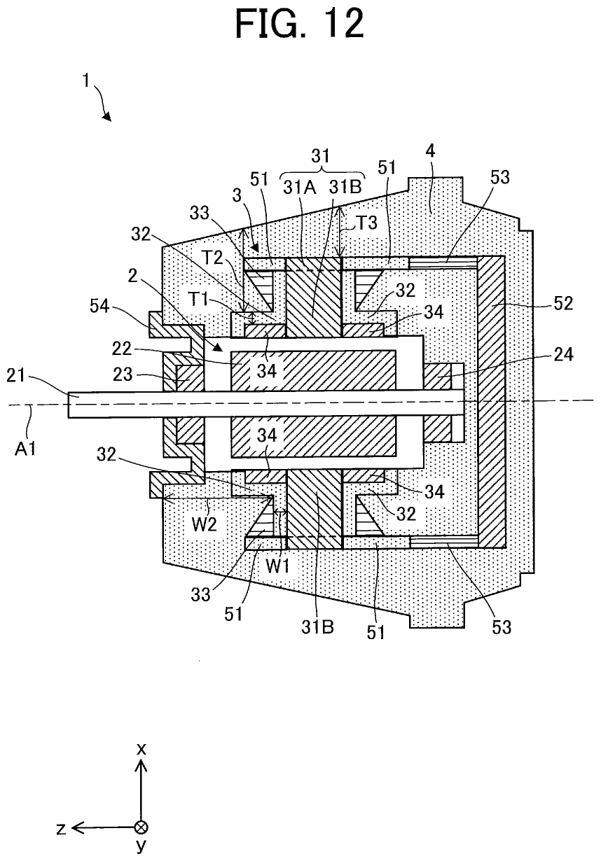

FIG. 12 is a cross-sectional view showing the electric motor shown in FIG. 1.

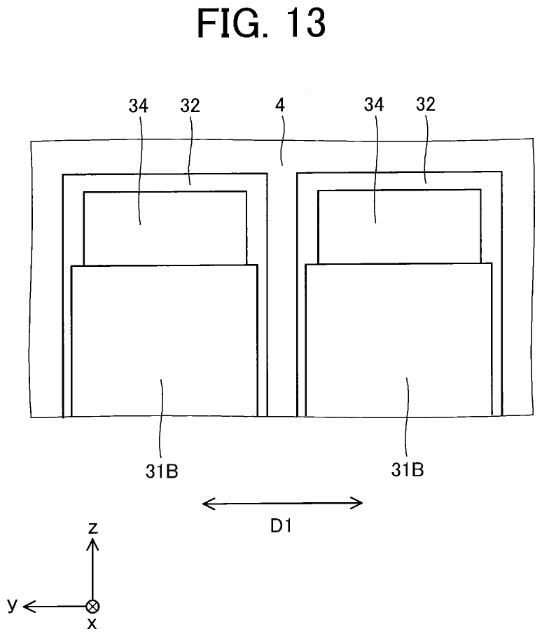

FIG. 13 is a diagram schematically showing an inner peripheral surface of a stator and an inner peripheral surface of a second insulator.

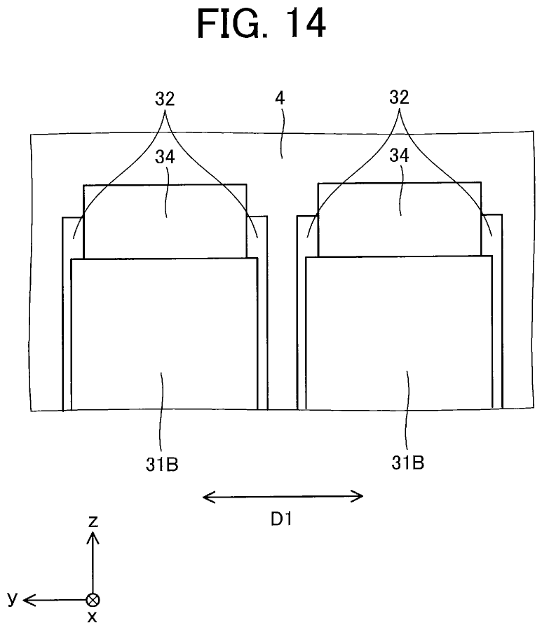

FIG. 14 is a diagram schematically showing another example of the inner peripheral surface of the stator and the inner peripheral surface of the second insulator.

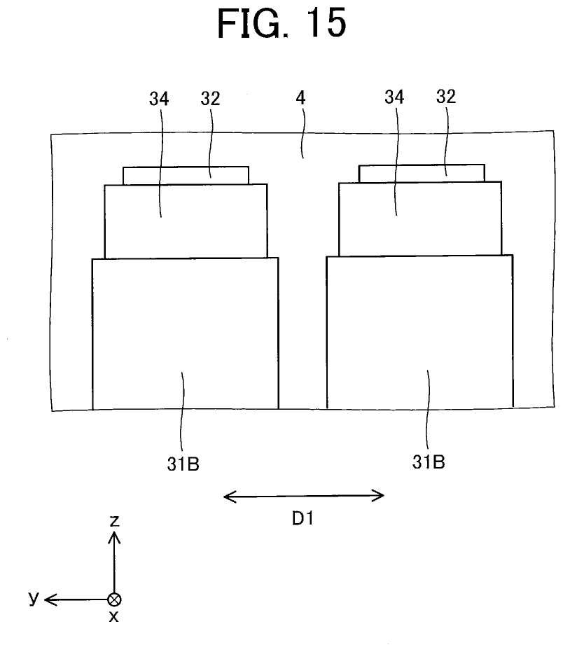

FIG. 15 is a diagram schematically showing still another example of the inner peripheral surface of the stator and the inner peripheral surface of the second insulator.

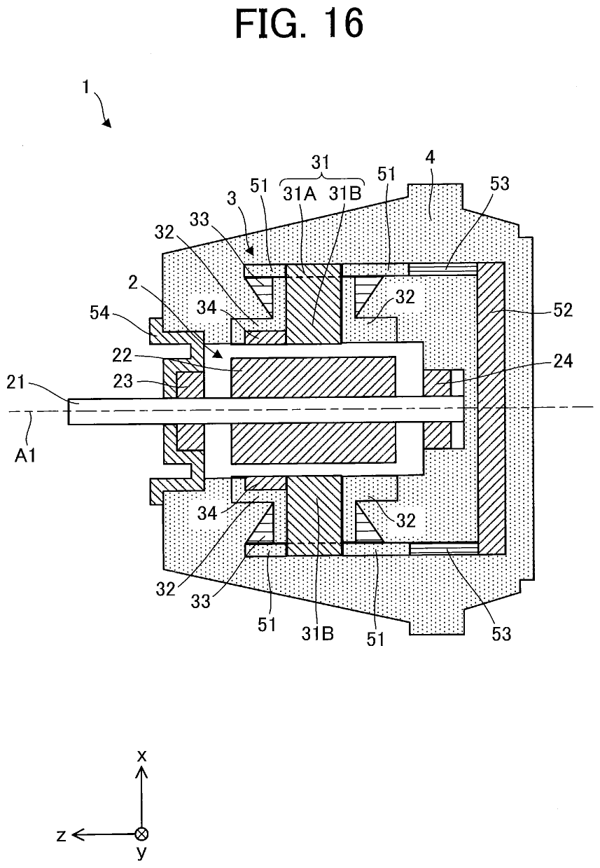

FIG. 16 is a cross-sectional view showing another example of the stator.

### MODE FOR CARRYING OUT THE INVENTION

### Embodiment

First embodiment according to an electric motor 1 will now be described hereafter.

In an xyz orthogonal coordinate system shown in each drawing, a z-axis direction (z axis) represents a direction parallel to the axis A1 of the electric motor 1, an x-axis direction (x axis) represents a direction orthogonal to the z-axis direction, and a y-axis direction (y axis) represents a direction orthogonal to both the z-axis direction and the x-axis direction. The axis A1 refers to the rotation center of a rotor 2, that is, the rotation axis of the rotor 2. The direction parallel to the axis A1 is also referred to as the “axis direction of the rotor 2” or simply the “axis direction.” A radial direction refers to a direction along a radius of the rotor 2, a stator 3, or a stator core 31, and refers to a direction orthogonal to the axis A1. An xy plane refers to a plane orthogonal to the axial direction. An arrow D1 represents a circumferential direction about the axis A1. A circumferential direction of the rotor 2, the stator 3, or the stator core 31 is also simply referred to as the “circumferential direction.”

FIG. 1 is a cross-sectional view schematically showing the electric motor 1 according to the embodiment.

The electric motor 1 includes the rotor 2, the stator 3, and a second insulator 4 covering the stator 3. The electric motor 1 is, for example, a permanent magnet synchronous motor.

As shown in FIG. 1, the electric motor 1 may further include at least one wall part 51, a circuit board 52, at least one terminal 53, and a bracket 54.

### Rotor 2

FIG. 2 is a cross-sectional view schematically showing the rotor 2.

The rotor 2 is disposed rotatably inside the stator 3. An air gap exists between the rotor 2 and the stator 3. The rotor 2 includes a shaft 21, a rotor core 22, and first and second bearings 23, 24 that rotatably support the shaft 21. The rotor 2 may include a permanent magnet to form the magnetic poles of the rotor 2. The rotor 2 is rotatable about the rotation axis (i.e., axis A1).

The shaft 21 is fixed to the rotor core 22. The shaft 21 is rotatably supported by the first bearing 23 and the second bearing 24.

The first bearing 23 is located outside the rotor core 22 in the axial direction. Specifically, the first bearing 23 is located on the load side of the electric motor 1 with respect to the rotor core 22. In the example shown in FIG. 1, the first bearing 23 is fixed to the bracket 54. The first bearing 23 rotatably supports the load side of the shaft 21.

The second bearing 24 is located outside the rotor core 22 in the axial direction. Specifically, the second bearing 24 is located on the anti-load side of the electric motor 1 with respect to the rotor core 22. In the example shown in FIG. 1, the second bearing 24 is fixed to the second insulator 4. The second bearing 24 rotatably supports the anti-load side of the shaft 21.

The first bearing 23 and the second bearing 24 are, for example, rolling bearings. When the first bearing 23 and the second bearing 24 are rolling bearings, the vibration of the rotor 2 due to the magnetic attractive force between the rotor 2 and the stator 3 can be prevented compared to plain bearings.

A part of the shaft 21 protrudes outward from the first bearing 23 in the axial direction. In the present embodiment, the load side of the shaft 21 protrudes outward from the first bearing 23 in the axial direction. The part of the shaft 21 protruding outward from the first bearing 23 is also referred to as a power transmission part. For example, the power transmission part of the shaft 21 is provided with a vane for generating airflow.

When the length between the two bearings 23 and 24 in the axial direction is L1 and the length of the rotor core 22 in the axial direction is L2, the relationship between L1 and L2 is L1≥ L2.

In the example shown in FIG. 2, the relationship between L1 and L2 is L1>L2. That is, the length L1 between the two bearings 23 and 24 in the axial direction is longer than the length L2 of the rotor core 22 in the axial direction.

FIG. 3 is a cross-sectional view showing another example of the rotor 2. The rotor 2 shown in FIG. 3 can be applied to the electric motor 1 shown in FIG. 1.

In the example shown in FIG. 3, the relationship between L1 and L2 is L1=L2. That is, the length L1 between the two bearings 23 and 24 in the axial direction is equal to the length L2 of the rotor core 22 in the axial direction.

### Stator 3

As shown in FIG. 1, the stator 3 includes a stator core 31, at least one first insulator 32 provided on the stator core 31, at least one winding 33 wound on the first insulator 32, and at least one magnetic material 34.

The stator core 31 includes a yoke 31A extending in the circumferential direction and a plurality of teeth 31B. In FIG. 1, the boundary between the yoke 31A and each of the teeth 31B is indicated by a dashed line. Each of the teeth 31B extends in the radial direction from the yoke 31A. The stator core 31 is a cylindrical core. For example, the stator core 31 is formed of a plurality of electrical steel sheets laminated in the axial direction. In this case, each of the electrical steel sheets is formed into a predetermined shape with blanking. These electromagnetic steel plates are fixed to each other by caulking, welding, gluing, etc. In the axial direction, the stator core 31 is shorter than the rotor core 22.

Each first insulator 32 insulates the stator core 31 and the magnetic material 34. Each first insulator 32 is, for example, an insulating resin. Each first insulator 32 is made of, for example, polybutylene terephthalate (PBT) or polyphenylene sulfide (PPS).

Each first insulator 32 is divided, for example, into a first portion adjacent to the magnetic material 34 and a second portion between the winding 33 and the stator core 31. In this case, the first portion of each first insulator 32 fixes the magnetic material 34, and the winding 33 is wound on the second portion of each first insulator 32.

In the example shown in FIG. 1, the first and second portions of each first insulator 32 are integrated as one component. However, in each first insulator 32, the first and second portions may be separated from each other.

Each magnetic material 34 is provided on one end of the tooth 31B in the axial direction so as to face the rotor core 22. Each magnetic material 34 extends in the axial direction so as to face the rotor core 22. In the example shown in FIG. 1, the magnetic materials 34 are provided on both sides of the stator core 31 in the axial direction.

In the example shown in FIG. 1, each magnetic material 34 is in contact with the stator core 31 (specifically, tooth 31B), but each magnetic material 34 need not necessarily be in contact with the stator core 31 (specifically, tooth 31B). In other words, each magnetic material 34 may be away from the stator core 31 (specifically, tooth 31B) in the axial direction.

The windings 33 are covered by the second insulator 4. Each winding 33 is made of, for example, aluminum wire.

The second insulator 4 covers the stator 3 and insulates the stator 3. The second insulator 4 is, for example, an insulating resin. The second insulator 4 is made of, for example, unsaturated polyester.

The density of the second insulator 4 is greater than the density of the first insulator 32.

Each magnetic material 34 is fixed by the first insulator 32. In the example shown in FIG. 1, each magnetic material 34 is fixed by the first insulator 32 in the radial direction of the rotor 2. Each magnetic material 34 is made of, for example, metal.

In the axial direction, each magnetic material 34 is fixed by at least one of the first insulator 32 or the second insulator 4.

FIG. 4 is an enlarged view showing a structure around the magnetic material 34 shown in FIG. 1.

In the example shown in FIG. 4, in the axial direction, each magnetic material 34 is covered by the first insulator 32. In the example shown in FIG. 4, in the axial direction, each magnetic material 34 is fixed by the first insulator 32. That is, in the example shown in FIG. 1, each magnetic material 34 is fixed by the first insulator 32 in both the radial direction and the axial direction. In the axial direction, the first insulator 32 is fixed by the second insulator 4.

FIG. 5 is an enlarged view schematically showing another structure around the magnetic material 34. The example shown in FIG. 5 can be applied to the electric motor 1 shown in FIG. 1.

In the example shown in FIG. 5, each magnetic material 34 is not covered by the first insulator 32 in the axial direction, and each magnetic material 34 is covered by the second insulator 4 in the axial direction. Thus, in the example shown in FIG. 5, each magnetic material 34 is fixed by the second insulator 4 in the axial direction.

FIG. 6 is an enlarged view schematically showing still another structure around the magnetic material 34. The example shown in FIG. 6 can be applied to the electric motor 1 shown in FIG. 1.

In the example shown in FIG. 6, each magnetic material 34 is covered by the first insulator 32 in the axial direction, and each magnetic material 34 is not covered by the second insulator 4 in the axial direction. Thus, in the example shown in FIG. 6, each magnetic material 34 is fixed by the first insulator 32 in the axial direction.

FIG. 7 is an enlarged view schematically showing still another structure around the magnetic material 34. The example shown in FIG. 7 can be applied to the electric motor 1 shown in FIG. 1.

In the example shown in FIG. 7, a part of each magnetic material 34 is covered by the first insulator 32 in the axial direction, and another part of each magnetic material 34 is covered by the second insulator 4 in the axial direction. Thus, in the example shown in FIG. 7, in the axial direction, each magnetic material 34 is fixed by both the first insulator 32 and the second insulator 4.

FIG. 8 is a cross-sectional view showing another example of the magnetic material 34. The example shown in FIG. 8 can be applied to the electric motor 1 shown in FIG. 1.

At least one magnetic material 34 may include a bend 34A. In the example shown in FIG. 8, the bend 34A protrudes toward the first insulator 32. In the example shown in FIG. 8, the bend 34A is adjacent to the stator core 31 (specifically, the tooth 31B). The bend 34A is engaged with the first insulator 32. With this configuration, the magnetic material 34 can be easily positioned.

FIG. 9 is a cross-sectional view showing still another example of the magnetic material 34. The example shown in FIG. 9 can be applied to the electric motor 1 shown in FIG. 1.

The example shown in FIG. 9 differs from the example shown in FIG. 8 in that the bend 34A is away from the stator core 31 (specifically, the tooth 31B). With this configuration, the magnetic material 34 can be easily positioned, and the vibration of the magnetic material 34 in the axial direction can be reduced.

FIG. 10 is a cross-sectional view showing still another example of the magnetic material 34. The example shown in FIG. 10 can be applied to the electric motor 1 shown in FIG. 1.

The example shown in FIG. 10 differs from the example shown in FIG. 8 in that at least one magnetic material 34 includes a plurality of bends 34A. The bends 34A are away from each other in the axial direction. Each bend 34A protrudes toward the first insulator 32 and engages with the first insulator 32. With this configuration, the magnetic material 34 can be easily positioned, and the vibration of the magnetic material 34 in the axial direction can be reduced.

FIG. 11 is a cross-sectional view showing still another example of the magnetic material 34. The example shown in FIG. 11 can be applied to the electric motor 1 shown in FIG. 1.

The example shown in FIG. 11 differs from the example shown in FIG. 8 in that the bend 34A is an end portion of the magnetic material 34 in the axial direction and is bent toward the first insulator 32. With this configuration, the magnetic material 34 can be easily positioned, and the vibration of the magnetic material 34 in the axial direction can be reduced.

FIG. 12 is a cross-sectional view showing the electric motor 1 shown in FIG. 1.

As shown in FIG. 12, the maximum thickness T1 of the first insulator 32 is the maximum thickness, in the radial direction, of the portion of the first insulator 32 between the second insulator 4 and the magnetic material 34. The maximum thickness T2 of the second insulator 4 is the maximum thickness of the portion of the second insulator 4 facing the first insulator 32 in the radial direction. In this case, the maximum thickness T2 is thicker than the maximum thickness T1. That is, in the radial direction, the maximum thickness T2 of the second insulator 4 facing the first insulator 32 is thicker than the maximum thickness T1 of the portion of the first insulator 32 between the second insulator 4 and the magnetic material 34.

As shown in FIG. 12, the maximum thickness W1 of the first insulator 32 is the maximum thickness, in the axial direction, of the portion of the first insulator 32 between the winding 33 and the stator core 31. The maximum thickness W2 of the second insulator 4 is the maximum thickness of the portion of the second insulator 4 facing the winding 33 in the axial direction. In this case, the maximum thickness W2 is thicker than the maximum thickness W1. That is, in the axial direction, the maximum thickness W2 of the second insulator 4 facing the winding 33 is thicker than the maximum thickness W1 of the portion of the first insulator 32 between the winding 33 and the stator core 31.

As shown in FIG. 12, the maximum thickness T3 of the second insulator 4 is the maximum thickness in the radial direction of the portion, which faces the stator core 31, of the second insulator 4. In this case, the maximum thickness T2 of the second insulator 4 is thicker than the maximum thickness T3 of the second insulator 4. That is, in the radial direction, the maximum thickness T2 of the portion, which faces the first insulator 32, of the second insulator 4 is thicker than the maximum thickness T3 of the portion, which faces the stator core 31, of the second insulator 4.

In the circumferential direction of the rotor 2, each magnetic material 34 is fixed by at least one of the first insulator 32 or the second insulator 4.

FIG. 13 is a diagram schematically showing the inner peripheral surface of the stator 3 and the inner peripheral surface of the second insulator 4.

In the example shown in FIG. 13, each magnetic material 34 is covered by the first insulator 32 in the circumferential direction of the rotor 2. Thus, in the example shown in FIG. 13, each magnetic material 34 is fixed by the first insulator 32 in the circumferential direction of the rotor 2.

FIG. 14 is a diagram schematically showing another example of the inner peripheral surface of the stator 3 and the inner peripheral surface of the second insulator 4. The example shown in FIG. 14 can be applied to the electric motor 1 shown in FIG. 1.

In the example shown in FIG. 14, a part of each magnetic material 34 is covered by the first insulator 32 in the circumferential direction of the rotor 2, and another part of each magnetic material 34 is covered by the second insulator 4 in the circumferential direction of the rotor 2. Thus, in the example shown in FIG. 14, each magnetic material 34 is fixed by both the first insulator 32 and the second insulator 4 in the circumferential direction of the rotor 2.

FIG. 15 is a diagram schematically showing still another example of the inner peripheral surface of the stator 3 and the inner peripheral surface of the second insulator 4. The example shown in FIG. 15 can be applied to the electric motor 1 shown in FIG. 1.

In the example shown in FIG. 15, each magnetic material 34 is not covered by the first insulator 32 in the circumferential direction of the rotor 2, and each magnetic material 34 is covered by the second insulator 4 in the circumferential direction of the rotor 2. Thus, in the example shown in FIG. 15, each magnetic material 34 is fixed by the second insulator 4 in the circumferential direction of the rotor 2.

### Wall Parts 51

Each wall part 51 (also referred to as a third insulator) is provided on the end portion of the stator core 31 in the radial direction. Each wall part 51 insulates the winding 33. Each wall part 51 is, for example, an insulating resin.

### Terminals 53

Each terminal 53 is fixed to the wall part 51. The terminals 53 electrically connect the winding 33 to the circuit board 52.

### Circuit Board 52

The circuit board 52 includes a control element for controlling the rotation of the rotor 2. The stator 3, the wall parts 51, the circuit board 52, and the terminals 53 are covered by the second insulator 4.

### Bracket 54

The bracket 54 is fixed to the end of the second insulator 4 in the axial direction. As a result, the interior of the second insulator 4 is sealed.

### Modification.

FIG. 16 is a cross-sectional view showing another example of the stator 3.

In the modification, at least one magnetic material 34 is provided on the load side with respect to the stator core 31 and is not provided on the anti-load side with respect to the stator core 31.

### Advantages of Present Embodiment

According to the present embodiment, the stator core 31 is shorter than the rotor core 22 in the axial direction, and at least one magnetic material 34, which is a component different from the stator core 31, faces the rotor core 22. Each magnetic material 34 extends in the axial direction so as to face the rotor core 22. With this configuration, magnetic flux from both sides of the rotor core 22 in the axial direction efficiently flows into the stator core 31 through each magnetic material 34. Therefore, compared to an electric motor in which the length of the stator core and the length of the rotor core in the axial direction are the same, the cost of the electric motor 1 can be reduced and the magnetic force in the electric motor 1 can be prevented from decreasing. As a result, the efficiency of the electric motor 1 can be prevented from decreasing.

In addition, in the present embodiment, the magnetic material 34 is fixed by the first insulator 32. Therefore, even when the magnetic flux from the rotor 2 and the winding 33 flows into the magnetic material 34, the vibration of the magnetic material 34 can be reduced.

In addition, in the present embodiment, the stator 3 is covered by the second insulator 4, and the density of the second insulator 4 is greater than the density of the first insulator 32. With this configuration, the noise passing through the first insulator 32 during the rotation of the rotor 2 can be reduced.

As a result, according to the present embodiment, the efficiency of the electric motor 1 can be prevented from reducing and the noise passing through the first insulator 32, which fixes the magnetic material 34, can be reduced.

When each magnetic material 34 is fixed by the first insulator 32 in the radial direction of the rotor 2, the vibration of the magnetic material 34 in the radial direction can be effectively reduced even when the magnetic flux from the rotor 2 and the winding 33 flows into the magnetic material 34.

When the maximum thickness T2 of the second insulator 4 facing the first insulator 32 in the radial direction is thicker than the maximum thickness T1 in the radial direction of the portion of the first insulator 32 between the second insulator 4 and the magnetic material 34, the noise passing through the first insulator 32 can be further reduced.

When the maximum thickness T2 of the second insulator 4 is thicker than the maximum thickness T3 of the second insulator 4 in the radial direction, the noise passing through the magnetic material 34, which is relatively more prone to vibration than the stator core 31, can be reduced.

When the maximum thickness W2 of the second insulator 4 facing the winding 33 in the axial direction is thicker than the maximum thickness W1, in the axial direction, of the portion of the first insulator 32 between the winding 33 and the stator core 31, the noise passing through the first insulator 32 can be further reduced.

When each magnetic material 34 is fixed by at least one of the first insulator 32 or the second insulator 4 in the circumferential direction of the rotor 2, the vibration of the magnetic material 34 in the circumferential direction can be effectively reduced even when the magnetic flux from the rotor 2 and the winding 33 flows into the magnetic material 34.

When each magnetic material 34 is fixed by at least one of the first insulator 32 or the second insulator 4 in the axial direction, the vibration of the magnetic material 34 in the axial direction can be effectively reduced even when the magnetic flux from the rotor 2 and the winding 33 flows into the magnetic material 34.

When the winding 33 is covered by the second insulator 4, the vibration of the winding 33 due to an electric current flowing through the winding 33 can be reduced.

When the relationship between the length L1 between the two bearings 23 and 24 in the axial direction and the length L2 of the rotor core 22 in the axial direction satisfies L1≥L2, even if a portion of the shaft 21 protrudes outward from the first bearing 23 in the axial direction, the force applied to the first bearing 23 due to the moment of a force can be reduced compared to the case where L1<L2. Therefore, the progress of wear of the first bearing 23 can be slowed down, and the portion protruding from the first bearing 23 can be prevented from bending. As a result, the noise in the electric motor 1 can be reduced.

When the relationship between the length L1 between the two bearings 23 and 24 in the axial direction and the length L2 of the rotor core 22 in the axial direction satisfies L1>L2, the portion protruding from the first bearing 23 can be effectively prevented from bending, and thus the noise in the electric motor 1 can be effectively reduced.

When each winding 33 is made of aluminum wire, the conductivity in each winding 33 can be reduced compared to a copper wire. For that reason, the winding 33 made of aluminum wire can be shortened compared to a winding made of copper wire, and thus the cost of the electric motor 1 can be reduced.

Aluminum wire usually has lower tensile strength than copper wire. For that reason, when each winding 33 is made of aluminum wire, fixing to the first insulator 32 is weak compared to a winding made of copper wire. However, even when each winding 33 is made of aluminum wire, the vibration of each winding 33 during the rotation of the rotor 2 can be reduced when the winding 33 is covered by the second insulation 4.

Instead of aluminum wire, each winding 33 may be made of aluminum alloy wire. Aluminum alloy wires have higher tensile strength than aluminum wires. For that reason, when each winding 33 is made of aluminum alloy wire, the vibration of each winding 33 during the rotation of the rotor 2 can be reduced compared to a winding made of aluminum wire.

In the modification, at least one magnetic material 34 is provided on the load side with respect to the stator core 31 and is not provided on the anti-load side with respect to the stator core 31. In this case, the cost of the electric motor 1 can be reduced, and the manufacturing of the electric motor 1 can be facilitated.

The features in each embodiment and each modification described above can be combined with each other.

### DESCRIPTION OF REFERENCE CHARACTERS

1 electric motor, 2 rotor, 3 stator, 4 second insulator, 21 shaft, 22 rotor core, 31 stator core, 31A yoke, 31B tooth, 32 first insulator, 33 winding, 34 magnetic material.

1. An electric motor comprising:
a stator including a stator core including a yoke and a tooth, a first insulator provided on the stator core, a winding wound on the first insulator;
a rotor including a rotor core and disposed inside the stator; and
a second insulator covering the stator, wherein
the stator core is shorter than the rotor core in an axial direction,
the stator includes a magnetic material fixed by the first insulator, the magnetic material facing the rotor core, and
density of the second insulator is greater than density of the first insulator.

2. The electric motor according to claim 1, wherein the magnetic material is fixed by the first insulator in a radial direction of the rotor.

3. The electric motor according to claim 1, wherein in a radial direction of the rotor, a maximum thickness of the second insulator facing the first insulator is thicker than a maximum thickness of a portion of the first insulator between the second insulator and the magnetic material.

4. The electric motor according to claim 1, wherein in a radial direction of the rotor, a maximum thickness of a portion, which faces the first insulator, of the second insulator is thicker than a maximum thickness of a portion, which faces the stator core, of the second insulator.

5. The electric motor according to claim 1, wherein in the axial direction, a maximum thickness of the second insulator facing the winding is thicker than a maximum thickness of a portion of the first insulator between the winding and the stator core.

6. The electric motor according to claim 1, wherein in a circumferential direction of the rotor, the magnetic material is fixed by at least one of the first insulator or the second insulator.

7. The electric motor according to claim 1, wherein in the axial direction, the magnetic material is fixed by at least one of the first insulator or the second insulator.

8. The electric motor according to claim 1, wherein the winding is covered by the second insulator.

9. The electric motor according to claim 1, wherein
the rotor includes a shaft fixed to the rotor core and rolling bearings rotatably supporting the shaft,
the rolling bearings are located outside the rotor core in the axial direction, and
a part of the shaft protrudes outward from the rolling bearing in the axial direction.

10. The electric motor according to claim 1, wherein the winding is made of aluminum wire.

11. The electric motor according to claim 2, wherein in a radial direction of the rotor, a maximum thickness of the second insulator facing the first insulator is thicker than a maximum thickness of a portion of the first insulator between the second insulator and the magnetic material.
